(19) United States
(12) Patent Application Publication
(10) Pub. No.: US 2021/0078142 A1
(43) Pub. Date: Mar. 18, 2021

(54) SLIDE TOOL

(71) Applicant: PO-YEN CHANG, Taichung City (TW)

(72) Inventor: PO-YEN CHANG, Taichung City (TW)

(21) Appl. No.: 16/571,638

(22) Filed: Sep. 16, 2019

(51) Int. Cl. B25B 13/46; B25B 13/48; B25B 23/00

(52) U.S. Cl. CPC B25B 13/465; B25B 23/0007; B25B 13/481

(57) ABSTRACT

A slide tool is provided, including a rod member, a sleeve member, a driving member, a restricting member and a control assembly. The sleeve member has a chamber, the chamber defines an axial direction, the sleeve member is sleeved on the rod member and slidable randomly relative to the rod member, and an interior circumferential wall of the chamber has an annular toothed portion. The driving member is disposed to the sleeve member and rotatable about the axial direction, the driving member includes an abutting portion and a driving portion which are connected to each other, and the abutting portion is located between the rod member and the driving portion. A side of the restricting member has an engaging toothed portion, and the engaging toothed portion is meshed with the annular toothed portion.

### BACKGROUND OF THE INVENTION

### Field of the Invention

The present invention relates to a slide tool.

### Description of the Prior Art

Generally, when fastening or disassembling fastening objects such as a screw or a nut, a user uses a slide tool (for example, a screwdriver or a socket) which has a shape corresponding to that of the fastening objects to screw the fastening objects. To increase a rotation speed, there are T-shaped sockets or T-shaped screwdrivers in the market, and the user can flip an extension arm which is lateral to an axial rod member to rotate quickly. In addition, to be used in different narrow spaces, a slide tool with an extension arm which is slidable relative to an axial rod member is provided, and the extension arm can slide toward one side to prevent the extension arm from interfering with the narrow space. Such slide tool is disclosed in TWI302492.

However, although the extension arm of the conventional slide tool is slidable relative to the axial rod member, the functionality of the slide tool is still not enough, and it is not appealing enough for consumers to purchase the above-mentioned slide tool to replace the traditional T-shaped socket or T-shaped screwdriver they already had.

The present invention has arisen to mitigate and/or obviate the afore-described disadvantages.

### SUMMARY OF THE INVENTION

The major object of the present invention is to provide a slide tool, which can rotate a fastening element in a direction to conduct fastening or disassembling operations, when the slide tool rotates the fastening element in the other direction, the slide tool will idle. Therefore, a functionality of the slide tool increases because the slide tool will not be limited by narrow spaces, and it is more convenient for fastening operations.

To achieve the above and other objects, a slide tool is provided, including a rod member, a sleeve member, a driving member, a restricting member and a control assembly. The sleeve member has a chamber, the chamber defines an axial direction, the sleeve member has a sleeve hole which is lateral to the axial direction, the sleeve member is sleeved on the rod member through the sleeve hole and slidable relative to the rod member, and an interior circumferential wall of the chamber has an annular toothed portion. The driving member is disposed to the sleeve member and rotatable about the axial direction, the driving member includes an abutting portion and a driving portion which are connected to each other, and the abutting portion is located between the rod member and the driving portion. A side of the restricting member has an engaging toothed portion, the engaging toothed portion is meshed with the annular toothed portion, and a side of the restricting member opposite to the engaging toothed portion is abutted against the abutting portion. The control assembly includes an adjusting member and an elastic member, the adjusting member is disposed to the sleeve member and rotatable about the axial direction, the elastic member is assembled respectively to the restricting member and the adjusting member, when the adjusting member rotates, the adjusting member drives the elastic member, and the elastic member drives the restricting member to swing relative to the abutting portion.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferred embodiment of the present invention;

FIGS. 2 and 3 are breakdown views of the preferred embodiment of the present invention;

FIGS. 4 and 5 are cross-sectional views of the preferred embodiment of the present invention in operation;

FIG. 6 is a stereogram of the preferred embodiment of the present invention; and

FIG. 7 is a cross-sectional view of FIG. 6, taken along line A-A.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

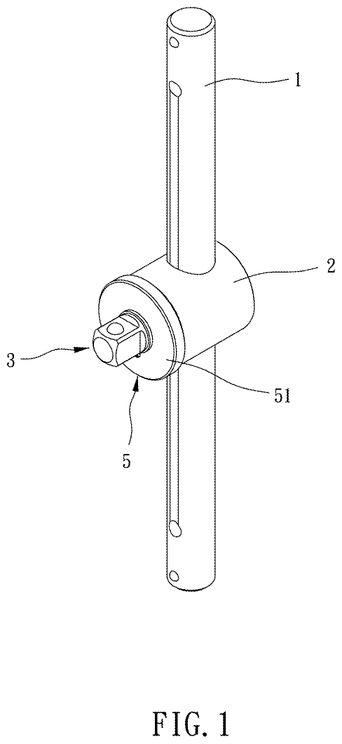

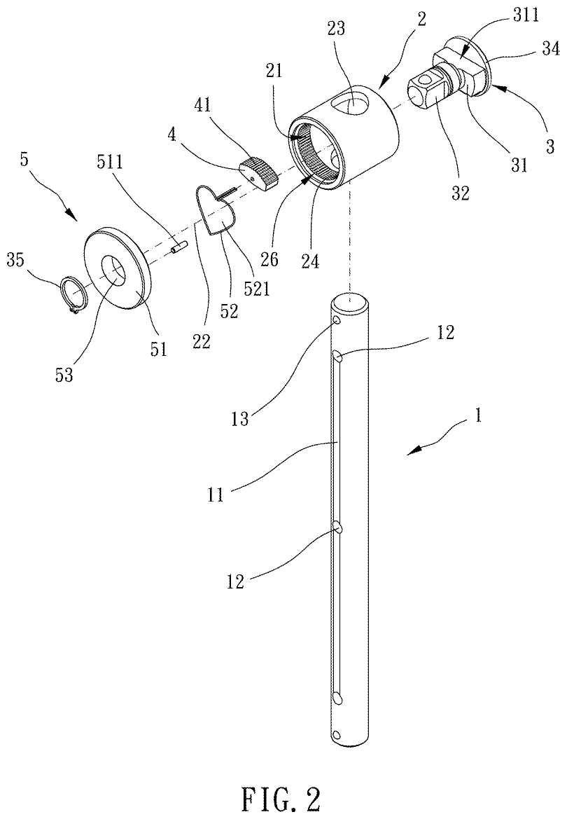

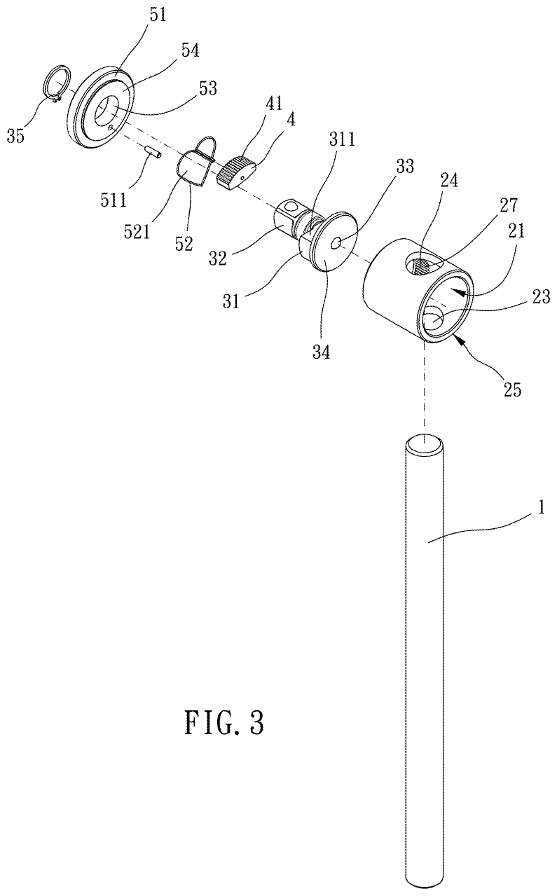

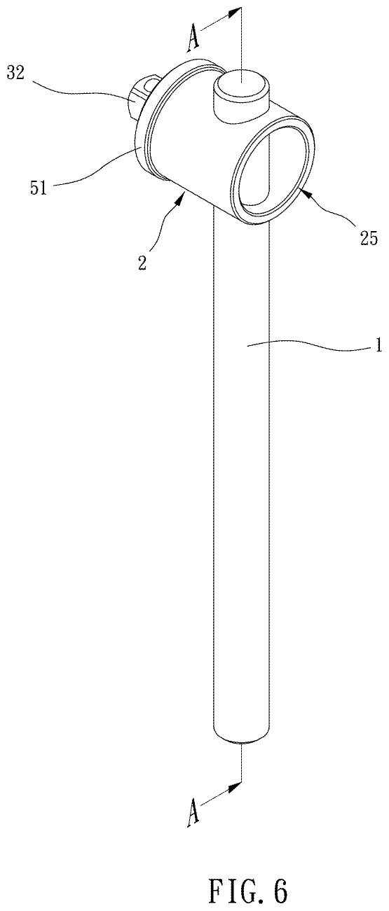

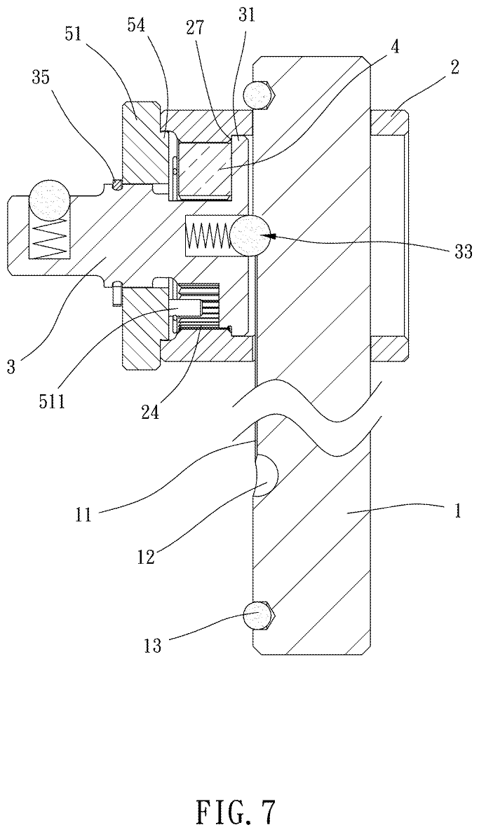

Please refer to FIGS. 1 to 7 for a preferred embodiment of the present invention. A slide tool includes a rod member 1, a sleeve member 2, a driving member 3, a restricting member 4 and a control assembly 5.

The sleeve member 2 has a chamber 21, the chamber 21 defines an axial direction 22, the sleeve member 2 has a sleeve hole 23 which is lateral to the axial direction 22, the sleeve member 2 is sleeved on the rod member 1 through the sleeve hole 23 and slidable relative to the rod member 1, and an interior circumferential wall of the chamber 21 has an annular toothed portion 24.

The driving member 3 is disposed to the sleeve member 2 and rotatable about the axial direction 22, the driving member 3 includes an abutting portion 31 and a driving portion 32 which are connected to each other, the abutting portion 31 is located between the rod member 1 and the driving portion 32, and the driving portion 32 is for being assembled to a fastening member (for example, a screw or a nut) or a fastening tool (for example, a socket) to drive.

A side of the restricting member 4 has an engaging toothed portion 41, the engaging toothed portion 41 is meshed with the annular toothed portion 24, and a side of the restricting member 4 opposite to the engaging toothed portion 41 is abutted against the abutting portion 31.

The control assembly 5 includes an adjusting member 51 and an elastic member 52, the adjusting member 51 is disposed to the sleeve member 2 and rotatable about the axial direction 22, the elastic member 52 is assembled respectively to the restricting member 4 and the adjusting member 51, when the adjusting member 51 rotates, the adjusting member 51 drives the elastic member 52, and the elastic member 52 drives the restricting member 4 to swing relative to the abutting portion 31.

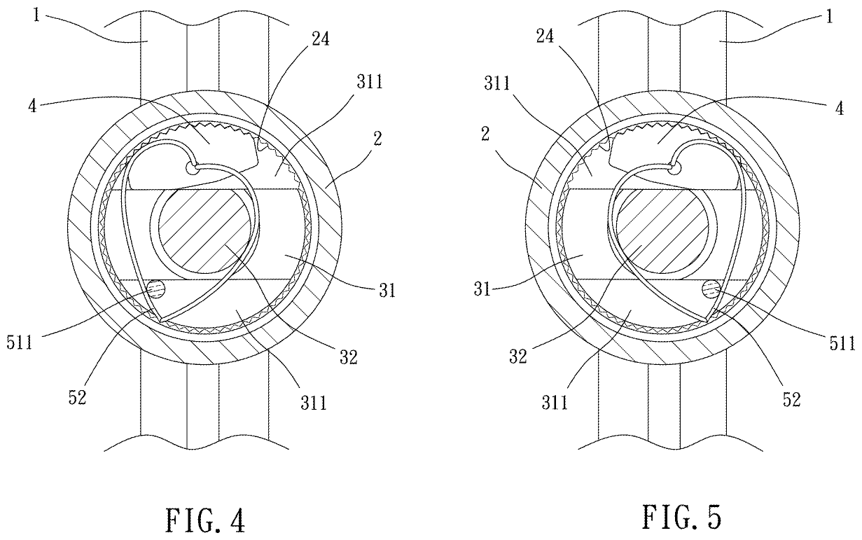

Thereby, as shown in FIG. 4, when the adjusting member 51 rotates clockwise, the elastic member 52 is driven, by the adjusting member, to move the restricting member 4 leftward; when the sleeve member 2 is driven by the rod member 1 and moves counter-clockwise, the restricting member 4 is meshed with the annular toothed portion 24, a left end of the restricting member 4 abuts against the abutting portion 31, and the driving member 3 is driven by the restricting member 4 to rotate counter-clockwise to conduct a fastening operation; when the sleeve member 2 is driven by the rod member 1 to rotate clockwise, the restricting member 4 is driven clockwise and non-abutted against the abutting portion 31; when the restricting member 4 is move for a distance and pulled back by the elastic member 52, the restricting member 4 and the annular toothed portion 24 are slipably engaged with each other so that the abutting portion 31 does not co-rotate with the sleeve member 2; when the sleeve member 2 rotates clockwise, the sleeve member 2 will not cause a reverse rotation of a fastener. As shown in FIG. 5, when the adjusting member 51 rotates counter-clockwise, the elastic member 52 is driven, by the adjusting member 51, to move the restricting member 4 rightward and cause an effect which is contrary to that caused by the mechanism shown in FIG. 4. Therefore, a user can control the adjusting member 51 to make the slide tool operate unidirectionally to increase the efficiency of the fastening operation.

Specifically, the rod member 1 has a slot 11 which extends along a longitudinal direction of the rod member 1, an end of the abutting member 31 on the axial direction 22 facing the rod member 1 has a bouncing member 33, the bouncing member 33 biases against the slot 11, the bouncing member 33 is positioningly restricted within the slot 11, and the rod member 1 is non-rotatable relative to the sleeve member 2 so that the rod member 1 can be easily operated to rotate the sleeve member 2. Preferably, the slot 11 has a plurality of holes 12, in this embodiment, there are three holes 12, the bouncing member 33 is disengageably engaged within one of the three holes 12, the user can adjust relative positions of the rod member 1 and the sleeve member 2 in accordance with his/her needs, two ends of the rod member 1 in the longitudinal direction respectively have a position-restricting member 13, and each said position-restricting member 13 has an exterior circumferential wall on a side facing the sleeve member 2 to block the sleeve member 2 to prevent the sleeve member 2 from being detached from the rod member 1.

Preferably, the sleeve member 2 has a first opening 25 and a second opening 26 which is opposite to the first opening 25 in the axial direction 22, the annular toothed portion 24 is located between the second opening 26 and the sleeve hole 23, an end of the annular toothed portion 24 facing the sleeve hole 23 and the interior circumferential wall of the chamber 21 define a stepped portion 27 therebetween, an end of the abutting portion 31 remote from the driving portion 32 has an annular flange 34 extending radially, the driving member 3 is placed, through the first opening 25, into the chamber 21, the annular flange 34 is engaged with the stepped portion 27, and the driving portion 32 projects beyond the chamber 21 from the second opening 26. Thereby, the annular flange 34 is engaged with the stepped portion 27, the bouncing member 33 biases against the rod member 1, and the driving member 3 can be positioningly restricted within the chamber 21.

In addition, the adjusting member 51 has a through hole 53, the adjusting member 51 covers the second opening 26 of the sleeve member 2, and the driving portion 32 is disposed through the through hole 53 to project beyond the chamber 21. Preferably, a blocking member 35 is detachably sleeved on the driving portion 32, the blocking member 35 is diametrically greater than the through hole 53 of the adjusting member 51, and the blocking member 35 abuts against a side of the adjusting member 51 remote from the sleeve member 2 to positioningly restrict the adjusting member 51, so the adjusting member 51 can freely rotate relative to the sleeve member 2.

In this embodiment, the adjusting member 51 is greater than the sleeve member 2 in radial dimension, a side of the adjusting member 51 facing the chamber 21 has a circular protrusion 54 which has a radial dimension smaller than the radial dimension of the adjusting member 51, and the circular protrusion 54 projects into the second opening 26 to prevent the adjusting member 51 from shaking relative to the sleeve member 2 and to ensure the adjusting member 51 rotate smoothly.

It is to be noted that the elastic member 52 defines a hitching portion 521, the hitching portion 521 is sleeved on the driving portion 32 so as not to interfere the driving member 3 from rotation, two ends of the elastic member 52 bend toward the axial direction 22 and are inserted into the restricting member 4, a side of the adjusting member 51 axially facing the restricting member 4 has a toggle 511, and the toggle 511 projects into the hitching portion 521 and toggles the hitching portion 521 of the elastic member 52 when the adjusting member 51 rotates. In this embodiment, the abutting portion 31 has two receiving sections 311 diametrically arranged, the restricting member 4 is received in one of the two receiving sections 311 so that the restricting member 4 can move within and smoothly abut against one of the two receiving sections 311, and the toggle 511 projects into the other of the two receiving sections 311 so that the toggle 511 can move within the other of the two receiving sections 311 to toggle the elastic member 52.

The sleeve member 2 is a cylindrical barrel so that the sleeve member 2 does not collide with objects easily during the fastening operation, the rod member 1 is a cylindrical rod, the sleeve hole 23 is a circular hole so that it is easier to form the sleeve hole 23, the abutting portion 31 is a rectangular block which has a plane for the restricting member 4 to abut thereagainst, and the driving portion 32 is a non-cylindrical post or non-circular recess. In this embodiment, the driving portion 32 is a non-circular cylinder for being assembled to a socket.

Given the above, in the slide tool, the sleeve member is sleeved on the rod member, the relative positions of the rod member and the sleeve member can be adjusted according to the user's needs, and the user can control the adjusting member to make the slide tool move unidirectionally and to increase the efficiency of the fastening operation.

While we have shown and described various embodiments in accordance with the present invention, it should be clear to those skilled in the art that further embodiments may be made without departing from the scope of the present invention.

What is claimed is:

1. A slide tool, including:
a rod member;
a sleeve member, having a chamber, the chamber defining an axial direction, the sleeve member having a sleeve hole which is lateral to the axial direction, the sleeve member being sleeved on the rod member through the sleeve hole and slidable relative to the rod member, an interior circumferential wall of the chamber having an annular toothed portion;
a driving member, disposed to the sleeve member and rotatable about the axial direction, including an abutting portion and a driving portion which are connected to each other, the abutting portion being located between the rod member and the driving portion;
a restricting member, a side thereof having an engaging toothed portion, the engaging toothed portion meshed with the annular toothed portion, a side of the restricting member opposite to the engaging toothed portion being abutted against the abutting portion;
a control assembly, including an adjusting member and an elastic member, the adjusting member being disposed to the sleeve member and rotatable about the axial direction, the elastic member being assembled respectively to the restricting member and the adjusting member, when the adjusting member rotates, the adjusting member drives the elastic member, and the elastic member drives the restricting member to swing relative to the abutting portion.

2. The slide tool of claim 1, wherein the rod member has a slot which extends along a longitudinal direction of the rod member, an end of the abutting member on the axial direction facing the rod member has a bouncing member, and the bouncing member biases against the slot.

3. The slide tool of claim 2, wherein the slot has a plurality of holes, the bouncing member is disengageably engaged within one of the plurality of holes, two ends of the rod member in the longitudinal direction respectively have a position-restricting member, and each said position-restricting member has an exterior circumferential wall on a side facing the sleeve member to block the sleeve member.

4. The slide tool of claim 1, wherein the sleeve member has a first opening and a second opening which is opposite to the first opening in the axial direction, the annular toothed portion is located between the second opening and the sleeve hole, an end of the annular toothed portion facing the sleeve hole and the interior circumferential wall of the chamber define a stepped portion therebetween, an end of the abutting portion remote from the driving portion has an annular flange extending radially, the driving member is placed, through the first opening, into the chamber, the annular flange is engaged with the stepped portion, and the driving portion projects beyond the chamber from the second opening.

5. The slide tool of claim 4, wherein the adjusting member has a through hole, the adjusting member covers the second opening of the sleeve member, and the driving portion is disposed through the through hole.

6. The slide tool of claim 5, wherein a blocking member is detachably sleeved on the driving portion, the blocking member is diametrically greater than the through hole of the adjusting member, and the blocking member abuts against a side of the adjusting member remote from the sleeve member.

7. The slide tool of claim 4, wherein the adjusting member is greater than the sleeve member in radial dimension, a side of the adjusting member facing the chamber has a circular protrusion which has a radial dimension smaller than the radial dimension of the adjusting member, and the circular protrusion projects into the second opening.

8. The slide tool of claim 1, wherein the elastic member defines a hitching portion, the hitching portion is sleeved on the driving portion, two ends of the elastic member bend toward the axial direction and are inserted into the restricting member, a side of the adjusting member axially facing the restricting member has a toggle, and the toggle projects into the hitching portion and toggles the hitching portion of the elastic member when the adjusting member rotates.

9. The slide tool of claim 8, wherein the abutting portion has two receiving sections diametrically arranged, the restricting member is received in one of the two receiving sections, and the toggle projects into the other of the two receiving sections.

10. The slide tool of claim 1, wherein the sleeve member is a cylindrical barrel, the rod member is a cylindrical rod, the sleeve hole is a circular hole, the abutting portion is a rectangular block, and the driving portion is a non-cylindrical post or non-circular recess; the rod member has a slot which extends along a longitudinal direction of the rod member, an end of the abutting member on the axial direction facing the rod member has a bouncing member, and the bouncing member biases against the slot; the slot has a plurality of holes, the bouncing member is disengageably engaged within one of the plurality of holes, two ends of the rod member in the longitudinal direction respectively have a position-restricting member, and each said position-restricting member has an exterior circumferential wall on a side facing the sleeve member to block the sleeve member; the sleeve member has a first opening and a second opening which is opposite to the first opening in the axial direction, the annular toothed portion is located between the second opening and the sleeve hole, an end of the annular toothed portion facing the sleeve hole and the interior circumferential wall of the chamber define a stepped portion therebetween, an end of the abutting portion remote from the driving portion has an annular flange extending radially, the driving member is placed, through the first opening, into the chamber, the annular flange is engaged with the stepped portion, and the driving portion projects beyond the chamber from the second opening; the adjusting member has a through hole, the adjusting member covers the second opening of the sleeve member, and the driving portion is disposed through the through hole; a blocking member is detachably sleeved on the driving portion, the blocking member is diametrically greater than the through hole of the adjusting member, and the blocking member abuts against a side of the adjusting member remote from the sleeve member; the adjusting member is greater than the sleeve member in radial dimension, a side of the adjusting member facing the chamber has a circular protrusion which has a radial dimension smaller than the radial dimension of the adjusting member, and the circular protrusion projects into the second opening; the elastic member defines a hitching portion, the hitching portion is sleeved on the driving portion, two ends of the elastic member bend toward the axial direction and are inserted into the restricting member, a side of the adjusting member axially facing the restricting member has a toggle, and the toggle projects into the hitching portion and toggles the hitching portion of the elastic member when the adjusting member rotates; the abutting portion has two receiving sections diametrically arranged, the restricting member is received in one of the two receiving sections, and the toggle projects into the other of the two receiving sections.
